(19) United States
(12) Patent Application Publication
(10) Pub. No.: US 2016/0039012 A1
(43) Pub. Date: Feb. 11, 2016

(54) Magnetic Coupling Spindle For Automatic Screwdrivers

(71) Applicant: Hsiu-Lin Hsu, New Taipei City (TW)

(72) Inventor: Hsiu-Lin Hsu, New Taipei City (TW)

(21) Appl. No.: 14/456,276

(22) Filed: Aug. 11, 2014

(51) Int. Cl. B23B 31/107; B25B 21/00

(52) U.S. Cl. CPC B23B 31/1071; B25B 21/00; B23B 2260/10

(57) ABSTRACT

A magnetic coupling spindle for automatic screwdrivers. The magnetic coupling spindle comprises: an axle shaft, configured with a bearing on its middle section; an axle cap, sleeved on one end of the axle shaft and covering the bearing; a sliding sleeve, sleeved on the end of the axle shaft far away from the axle cap. The sliding sleeve can slide along the axial direction and on the end toward the direction of the axle cap, a magnet is configured. The part of the periphery of the axle shaft sleeved by the sliding sleeve is formed with a slightly raised stage section extending from the toe, so that the sliding sleeve will not fall apart due to the sliding.

### BACKGROUND OF INVENTION

1. Field of the Invention

The present invention relates generally to an improvement of the function of automatic screwdrivers, and more particularly to an improvement of the coupling spindles for automatic screwdrivers which not only have dual functions of fast coupling and clamping, but also provide reliable coupling and secure clamping when the automatic screwdriver is coupled with various screwdriver bits, so as to enhance the preciseness of screw locking operations and obtain good locking quality.

2. Description of Related Art

The main components of currently known automatic screwdrivers include: a motor mechanism for power output, a gear mechanism for power transmission and speed shifting, a clutch mechanism to provide a preset torque, a chuck mechanism for binding and separating of the screwdriver bit, and a trigger mechanism to provide the operating buttons; with such components, the automatic screwdriver can be coupled with various screwdriver bits through the chuck mechanism for different screw locking operations and effects.

The above-stated chuck mechanism usually includes: a coupling spindle, for insertion of the screwdriver bit; a collar, sleeved on the toe of the coupling spindle, and configured with an internally embedded steel ball, to keep the screwdriver bit in position; a spring, embedded between the coupling spindle and the collar, for the collar to fix or release the screwdriver bit through the sliding function; a clasp to keep the spring in position. Based on this, when coupling a screwdriver bit, slide the collar and insert the butt end of the screwdriver bit, and then release the collar. Through the elastic restoring force of the spring, the collar will enclose the butt end of the screwdriver bit, and when the steel ball falls into the ring-shaped groove below the butt end, the screwdriver bit will be fixed. In this way, the screwdriver bit can be coupled quickly. To remove the screwdriver bit, slide the collar to let the steel ball separate from the ring-shaped groove, and release the limitation of the screwdriver bit, so that it can be easily removed and replaced.

In usage, the above-stated prior-art chuck mechanism for automatic screwdrivers virtually poses no big problems, and can meet the pure locking needs of general users. However, in order for the products to survive in the market, the functions of current products shall be constantly improved. Particularly for the chuck mechanism, as the fixing structure of general and common screwdriver bits is a ring-shaped groove configured below the butt end, to correspond this design, a steel ball is configured on the internal wall of the sleeve of the chuck mechanism for clasping; however, this coupling method can only provide binding and fixing of the chuck mechanism and the screwdriver bit, but can not limit the rotation of the screwdriver bit. Therefore it is unable to obtain the correctness and preciseness required by accurate screw locking operations.

### SUMMARY OF THE INVENTION

The main objective of the present invention is to provide a magnetic coupling spindle for automatic screwdrivers. Based on the multi-function of the magnetic coupling spindle providing fast magnetic coupling and dual clamping, when the automatic screwdriver is coupled with various screwdriver bits, it can provide reliable coupling and secure clamping so as to enhance the preciseness of screw locking operations and obtain good locking quality.

To fulfill the above objective, the present invention designed and developed an improved magnetic coupling spindle for automatic screwdrivers. The outside of the automatic screwdriver is covered by a shell, and inside it is at least configured with: a motor mechanism, a gear mechanism, a torque mechanism, a chuck mechanism, and a trigger mechanism. The coupling spindle is configured inside the chuck mechanism and is coupled with and moves along each of the above mechanisms; particularly: the magnetic coupling spindle comprises: an axle shaft, configured with a bearing on its middle section; an axle cap, sleeved on one end of the axle shaft and covering the bearing; a sliding sleeve, sleeved on the end of the axle shaft far away from the axle cap. The sliding sleeve can slide along the axial direction and on the end toward the direction of the axle cap, a magnet is configured. The part of the periphery of the axle shaft sleeved by the sliding sleeve is formed with a slightly raised stage section extending from the toe, so that the sliding sleeve will not fall apart due to the sliding; furthermore, on the toe of the axle shaft sleeved by the sliding sleeve, a binding cleft is provided in a concave way for the screwdriver bit to be inserted in.

The periphery of the above axle shaft sleeved by the sliding sleeve is further provided with a positioning hole and more than one clamping holes arranged around the axle shaft with some spacing. Inside the positioning hole and each clamping hole, a steel ball is provided.

The binding cleft on one end of the above axle shaft can be of any geometric shape to match the different butt end shapes of currently common screwdriver bits, such as round, square, polygon etc.

The above magnetic coupling spindle can suit various automatic screwdrivers, such as any of the electric, pneumatic and semi-automatic screwdrivers.

The above sliding sleeve can be provided with a magnet on the end far away from the axle cap.

### BRIEF DESCRIPTION OF THE DRAWINGS

FIG. 1 is a structural drawing of the present invention depicting the application of the magnetic coupling spindle for automatic screwdrivers in an automatic screwdriver.

FIG. 2 is a structural drawing of the present invention depicting the appearance of the magnetic coupling spindle for automatic screwdrivers.

FIG. 3 is an assembled explosive view of the present invention of a magnetic coupling spindle for automatic screwdrivers.

FIG. 4 is a schematic view of the present invention depicting the combination state between the magnetic coupling spindle for automatic screwdrivers and the screwdriver bit.

FIG. 5 is a state view of the present invention depicting the screwdriver bit removed from the magnetic coupling spindle for automatic screwdrivers.

FIG. 6 is an explosive view of the present invention depicting the implementation state of the magnetic coupling spindle for automatic screwdrivers.

### DETAILED DESCRIPTION OF THE INVENTION

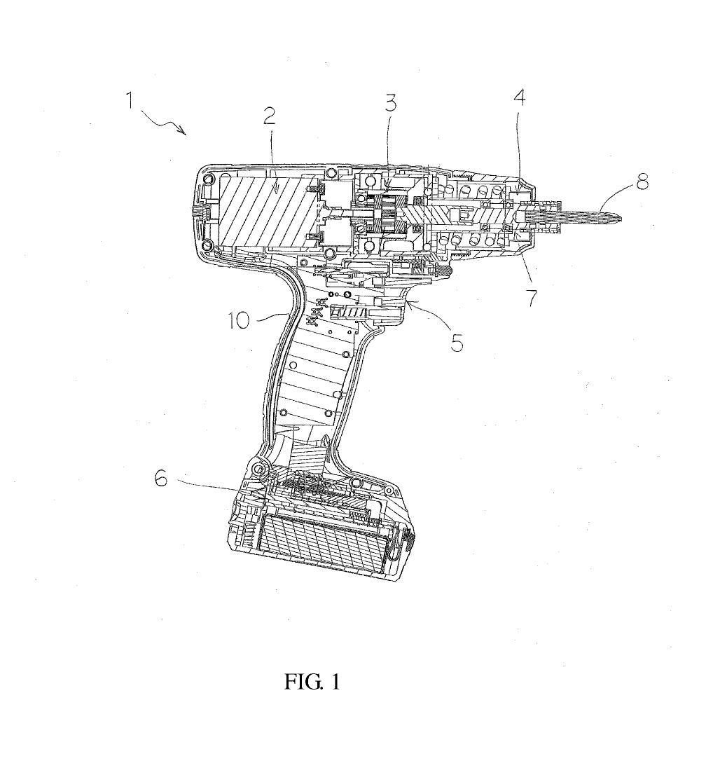

Referring to FIG. 1, the structural drawing of a gun-shaped automatic screwdriver is disclosed. The automatic screwdriver can be of any type, such as electric or pneumatic, and the appearance is not limited, usually upright or in the shape of a gun.

The structure of the automatic screwdriver 1 is similar to conventional ones, comprising: an outside shell 10; and inside the shell 10, at least provided with: a motor mechanism 2, a clutch mechanism 3, a chuck mechanism 4, a trigger mechanism 5, and a controller mechanism 6; wherein, the motor mechanism 2 is to provide the power source; the clutch mechanism 3 has a gear structure combined with clutch, cam and torque structures, and is coupled with and driven by the motor, so as to provide effective power transmission and speed shifting, and provide a preset torque output; the chuck mechanism 4 is driven by the clutch mechanism 3, and can be coupled with various screwdriver bits 8 through insertion; the trigger mechanism 5 is to control the start of the operation of the automatic screwdriver, and meanwhile has a function to avoid button reset; the controller mechanism 6 has a built-in microcontroller panel, and provides the required power source.

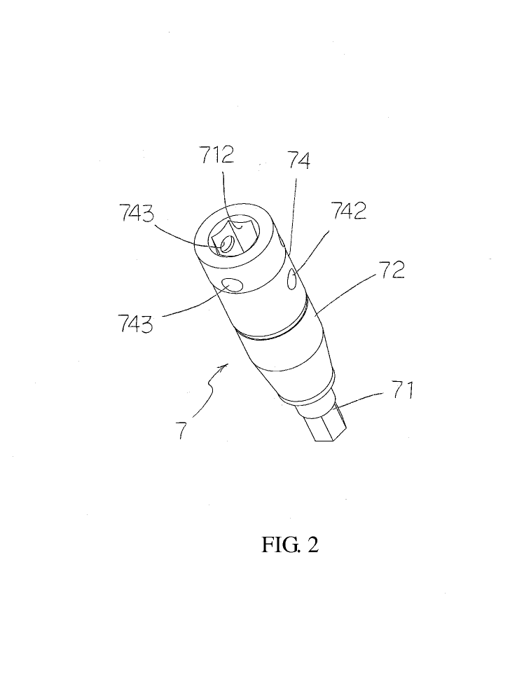

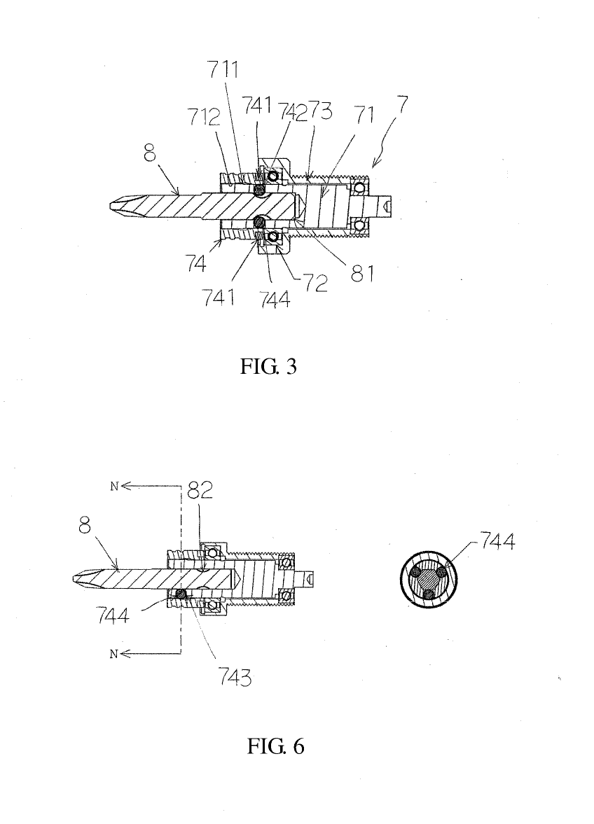

Referring to FIG. 2, the characteristics of the improvement of the present invention are as follow: the chuck mechanism 4 of the automatic screwdriver 1 is improved to facilitate fast and reliable combination with various styles of screwdriver bits 8. Based on this, the improved design of the magnetic coupling spindle 7 disclosed in the present invention is provided inside the above chuck mechanism 4, and is coupled with the impulse lever 41 inside the chuck mechanism 4 on the same axle; in this way, when the magnetic coupling spindle 7 is coupled with various styles of screwdriver bits 8, the screwdriver bit 8 can be driven to rotate through the serial power transmission by each of the components inside the automatic screwdriver 1, to fulfill the screw-locking operation. The detailed structure of the magnetic coupling spindle 7 is depicted in FIGS. 2 and 3. It mainly comprises an axle shaft 71, configured with a bearing 72 on its middle section; an axle cap 73, sleeved on one end of the axle shaft 71 and covering the bearing 72, with screw threads on the periphery of the axle cap 73 for coupling and fixing; a sliding sleeve 74, sleeved on the end of the axle shaft 71 far away from the axle cap 73. The sliding sleeve 74 can slide along the axial direction and on the end toward the direction of the axle cap 73, a magnet 741 is configured. The part of the periphery of the axle shaft 71 sleeved by the sliding sleeve 74 is formed with a slightly raised stage section 711 extending from the toe, so that the sliding sleeve 74 will not fall apart due to the sliding. Furthermore, the toe of the axle shaft 71 sleeved by the axle cap 73 is coupled with and moves along the coupling shaft 31 configured inside the clutch mechanism 3. On the toe of the axle shaft 71 sleeved by the sliding sleeve 74, a binding cleft 712 is provided in a concave way for various screwdriver bits 8 to be inserted in and coupled. The binding cleft 712 can be of any geometric shape to match different shapes of the butt ends 81 of currently common screwdriver bits, such as round, square, polygon etc; furthermore: the periphery of the axle shaft 71 sleeved by the sliding sleeve 74 is further provided with a positioning hole 742 and more than one clamping holes 743 arranged around the axle shaft with some spacing. Inside the positioning hole 742 and each clamping hole 743, a steel ball 744 is provided.

The above magnet 741 configured on the end of the sliding sleeve 74 toward the direction of the axle cap 73 can also be configured on the end of the sliding sleeve 74 far away from the axle cap 73, like the sliding sleeve on one end of the magnetic coupling spindle depicted in FIG. 1; based on this, through magnetic absorption, the magnetic coupling spindle 7 can be quickly coupled with various screwdriver bits 8, and make the sliding sleeve 74 quickly positioned.

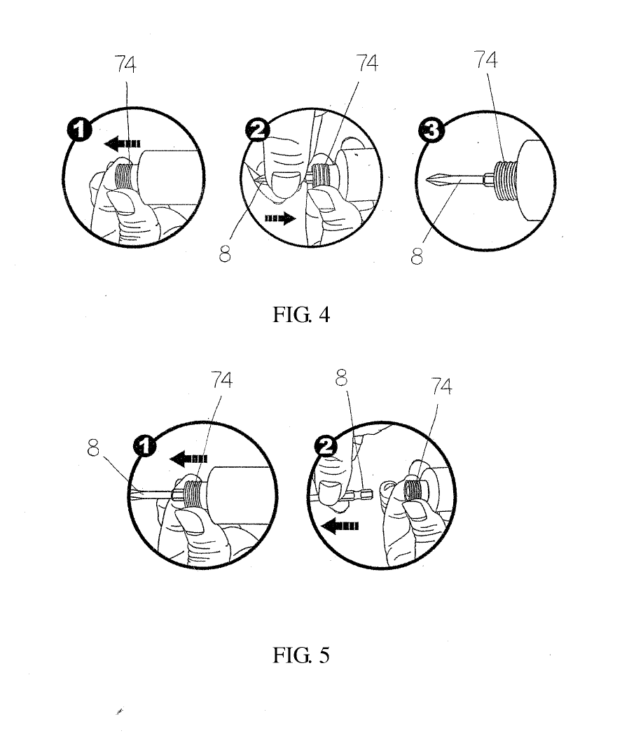

Now refer to FIGS. 4 and 5 together. As shown in FIG. 4, based on the structure of the above magnetic coupling spindle 7, when coupling with a screwdriver bit 8, the sliding sleeve 74 is pulled out from the axle shaft 71 to have an axial displacement away from the bearing 72, so that the sliding sleeve 74 releases its pressure on all of the steel balls 744. At this point, the coupling butt end 81 of the screwdriver bit 8 can be inserted into the binding cleft 741, and after positioning, release the sliding sleeve 74 for a fast reset through the absorption of the magnet 741, so as to recover the pressure of the sliding sleeve 74 on all of the steel balls 744, and reliably fix the screwdriver bit 8 on the chuck mechanism 4 to move together. In this way, dual functions of fast positioning and reliable clamping are realized. Referring to FIG. 5, relatively, when removing the screwdriver bit 8, the sliding sleeve 74 is also pulled out, so that the sliding sleeve 74 releases its pressure on all of the steel balls 744. At this point, the user can easily detach the screwdriver bit 8 from the magnetic coupling spindle 7.

The structure of the above magnetic coupling spindle 7 can suit all automatic screwdrivers, such as electric, pneumatic or semi-automatic screwdrivers. The size of the magnetic coupling spindle 7 may have some difference to match different types of automatic screwdrivers, but this part is just a simple modification.

Further refer to FIGS. 3 and 6 together. The combined and explosive views of the magnetic coupling spindle and screwdriver bit are disclosed; The coupling butt end 81 of the screwdriver bit 8 is inserted into and positioned inside the binding cleft 712 of the magnetic coupling spindle 7, and the sliding sleeve 74 is reset through the absorption of the magnet 741. The sliding sleeve 74 will have a pressure on all of the steel balls 744 in the positioning hole 742 and clamping holes 743 configured on the periphery of the axle shaft 71, so that the steel ball 744 inside the positioning hole 742 will fall into the ring-shaped groove 82 on the periphery of the screwdriver bit 8, while the steel balls 744 inside the clamping hole 743 are pressed by the sliding sleeve 74 to have a clamping effect upon the coupling butt end 81 of the screwdriver bit 8; as shown in FIG. 4, the steel ball 744 inside the positioning hole 742 has fallen into the ring-shaped groove 82 on one side of the coupling butt end 81 of the screwdriver bit 8; as shown in FIG. 5, all the steel balls 746 inside the clamping holes 743 clamp around the periphery of the coupling butt end 81 of the screwdriver bit 8 in a triangular arrangement. Particularly, no matter what shape is the coupling butt end 81 of the screwdriver bit 8, it can be synchronously clamped by the steel balls 744 inside the multiple clamping holes 743 arranged in a ring, realizing a reliable coupling and positioning.

From the above descriptions, it is known that, on one hand, the present invention of an improvement of the magnetic coupling spindle for automatic screwdrivers provides fast coupling and reliable clamping to avoid idling of the screwdriver bit to affect the screw locking quality and accuracy; on the other hand, it can have wide applications in the chuck mechanism of automatic screwdrivers of various specifications, shapes and styles. With a wider range of applications, the usage is more flexible. Meanwhile, the overall quality of the automatic screwdriver is enhanced. With the improved functions and structures, the automatic screwdriver will be more competitive in the market.

To sum up, in contrast to the structure of conventional automatic tools that couple with a screwdriver bit simply through clamping, the present invention of a “magnetic coupling spindle for automatic screwdrivers” offers apparent improvements in fast coupling and removing as well as dual functions of positioning and clamping. It has obvious industrial applicability, and fully meets the requisites for utility patent. Hence, an application is submitted in accordance with the Patent Law.

Although the invention has been explained in relation to its preferred embodiment, it is to be understood that many other possible modifications and variations can be made without departing from the spirit and scope of the invention as hereinafter claimed.

1. A magnetic coupling spindle for automatic screwdrivers comprises an automatic screwdriver covered by a shell, inside the said shell it is provided with at least: a motor mechanism, a gear mechanism, a torque mechanism, a chuck mechanism, and a trigger mechanism; the coupling spindle is configured inside the chuck mechanism and is coupled with and moves along each of the above mechanisms; characteristically: the magnetic coupling spindle comprises: an axle shaft, configured with a bearing on its middle section; an axle cap, sleeved on one end of the axle shaft and covering the bearing; a sliding sleeve, sleeved on the end of the axle shaft far away from the axle cap; the sliding sleeve can slide along the axial direction and on the end toward the direction of the axle cap, a magnet is configured; the part of the periphery of the axle shaft sleeved by the sliding sleeve is formed with a slightly raised stage section extending from the toe, so that the sliding sleeve will not fall apart due to the sliding; furthermore, on the toe of the axle shaft sleeved by the sliding sleeve, a binding cleft is provided in a concave way for the screwdriver bit to be inserted in.

2. The magnetic coupling spindle for automatic screwdrivers as claimed in claim 1, wherein the periphery of the above axle shaft sleeved by the sliding sleeve is further provided with a positioning hole and more than one clamping holes arranged around the axle shaft with some spacing; inside the positioning hole and each clamping hole, a steel ball is provided.

3. The magnetic coupling spindle for automatic screwdrivers as claimed in claim 1, wherein the binding cleft can be of any geometric shape to match the different butt end shapes of currently common screwdriver bits, such as round, square, polygon etc.

4. The magnetic coupling spindle for automatic screwdrivers as claimed in claim 1, wherein the magnetic coupling spindle can suit various automatic screwdrivers, such as any of the electric, pneumatic and semi-automatic screwdrivers.

5. The magnetic coupling spindle for automatic screwdrivers as claimed in claim 1, wherein the sliding sleeve is provided with a magnet on the end far away from the axle cap.
